(19) United States
(12) Patent Application Publication
(10) Pub. No.: US 2026/0028878 A1
(43) Pub. Date: Jan. 29, 2026

(54) LADDER SYSTEM AND METHOD OF MANUFACTURING

(71) Applicant: Steven Aulenbacher, Richfield, WI (US)

(72) Inventor: Steven Aulenbacher, Richfield, WI (US)

(21) Appl. No.: 18/785,333

(22) Filed: Jul. 26, 2024

(51) Int. Cl. E06C 9/04

(52) U.S. Cl. CPC E06C 9/04

(57) ABSTRACT

A multipurpose and adaptable ladder system includes one or more climbing sections. Each climbing section includes a channel having a web with a front surface, a rear surface opposite the front surface, and a plurality mounting holes. Each mounting hole extends from the front surface through the rear surface and is configured to receive a fastener for mounting the climbing section. The channel also includes first and second flanges extending away from the rear surface of the web to form a channel opening therebetween. Each climbing section further includes one or more climbing steps. Each climbing step extends from the front surface of the web, includes a climbing surface, and is configured to receive at least one hand and/or at least one foot of a climber.

### BACKGROUND OF THE INVENTION

Embodiments of the present invention relate to ladder systems and, more particularly, to multipurpose and adaptable ladder systems couplable to different surfaces.

People working or engaging in various types of industries and activities often use the same type of equipment configured in a different manner. These different equipment configurations are often specialized for the relevant industries and activities. One type of equipment that has many different configurations for many different purposes is ladders. As one example, telephone and power line technicians use ladders on telephone and utility poles. As another example, hunters use ladders to climb up to their tree stands. As yet another example, workers installing or performing maintenance on roofs use ladders both to get onto roofs and to climb up and down steep roofs.

Regardless of the industry or activity involved, ladders may be deficient, even when they are specifically designed for that purpose. For example, tree stand ladders are often designed to be attached to a tree via straps that extend around the tree and are difficult to install. Such ladder attachment systems are bulky and hard to maneuver. Further, they often require multiple people to install correctly, especially when the chosen tree is large and/or has branches that will be hard to avoid when extending the strap around the tree. Thus, these tree stand ladders are highly inconvenient to the owner and/or installers.

Furthermore, these ladders do not provide an especially safe method of attachment. The ladder is not firmly attached to the tree and is instead left without a strong supporting structure. Keeping the ladder level during installation is also difficult. When not installed correctly, the ladder may be improperly angled, and a climber may become unbalanced and fall to the ground. Moreover, even when installed correctly, a climber will experience some amount of bouncing away from the tree during a climb, which will, at the very least, be distracting to the climber.

In addition, when the attachment straps are left on a tree for an extended period of time, the tree will grow over the strap. As a result, the owner of the ladder will not be able to take down the ladder without first freeing the strap from the tree. Freeing the strap will require either cutting or breaking apart the tree, which may be difficult or not allowed, or cutting the strap itself. In either case, this is an inconvenience to the owner of the ladder. In the latter case, the owner will need to buy at least a new strap, which increases the cost of owning the ladder.

One alternative to using a strap-based ladder system on a tree is a system with a plurality of individual steps that act as both handholds and footholds for a climber. These steps have built-in fasteners that are designed for an installer to crank into the tree by hand. While the small size of these individual steps may be convenient for an installer to carry up the tree, the small size poses some problems for climbers. For example, the small size of the steps does not provide much area for a climber's foot. As another example, since the fasteners secure the steps directly on the tree, climbers are crowded against the tree when climbing. Another issue with these steps is the great amount of energy an installer will expend hand-cranking enough of the steps into the tree to get up to the tree stand.

With respect to telephone and utility pole ladders, these ladders use pole steps configured as pegs embedded in and extending out of a wooden pole that a technician must climb to reach and access telephone lines, power lines, and/or other communications/power components. However, these pegs may not be strong enough or may not be installed in a manner that lasts for an extended period of time and must be replaced. For example, the pegs may not be embedded properly in the pole or the wood of the pole can become fragmented or deteriorate (for example, due to rot or termites) to the point where stepping on a peg will cause the peg to be ripped out of the utility pole. Such weaknesses in a telephone or utility pole ladder could cause a technician to fall and suffer injury. Additionally, the shape and size of the pegs may make it uncomfortable for a technician to climb and work on the ladder. Moreover, embedding the pegs in the poles is time consuming, and since the pegs are not readily removable, anyone with access to the pole may climb the ladder, regardless of whether they are approved to do so.

Regarding use of ladders on roofs, workers often use straight ladders to climb up and down roofs that are too steep to walk up and down safely. When using a straight ladder on a roof, the ladder needs another object to support it. For example, workers may fasten one or more brackets to the roof and then secure the ladder into hooks on the brackets. In this case, the workers have an increased cost for the brackets and increased time to install the brackets before being able to use the ladder. As another example, workers may install a hook onto the ladder itself and hook the ladder over a peak of the roof. As with the brackets, the hook imposes an increased cost on the workers. Further, while the hook provides flexibility in that the workers can simply move the ladder along the peak of the roof to adjust its position, the workers can easily lose control of the ladder and/or place the hook in an unsafe position in which the ladder is no longer secured over the roof peak. The ladder may then fall off of the roof, causing injury to the climber, injury to others on site, and/or property damage.

It would therefore be desirable to provide a safer, more efficient, and more consumer-friendly ladder system and methods of manufacturing such a ladder system.

### BRIEF STATEMENT OF THE INVENTION

In accordance with one aspect of the invention, a ladder system includes one or more climbing sections. Each climbing section includes a channel having a web with a front surface, a rear surface opposite the front surface, and a plurality mounting holes. Each mounting hole extends from the front surface through the rear surface and is configured to receive a fastener for mounting the climbing section. The channel also includes first and second flanges extending away from the rear surface of the web to form a channel opening therebetween. Each climbing section further includes one or more climbing steps. Each climbing step extends from the front surface of the web, includes a climbing surface, and is configured to receive at least one hand and/or at least one foot of a climber.

In accordance with another aspect of the invention, a method of manufacturing a ladder system includes forming one or more climbing sections. Forming the one or more climbing sections includes forming a channel for each climbing section of the one or more climbing sections. The channel of each climbing section of the one or more climbing sections includes a web having a front surface, a rear surface opposite the front surface, and a plurality mounting holes, each mounting hole extending from the front surface through the rear surface and configured to receive a fastener for mounting the climbing section. The channel for each climbing section additionally includes first and second flanges extending away from the rear surface of the web to form a channel opening therebetween. Furthermore, forming the one or more climbing sections includes forming one or more climbing steps for each climbing section of the one or more climbing sections by forming one or more discrete climbing steps separately from each channel of the one or more climbing sections, forming one or more integral climbing steps integrally with the channel of at least one climbing section of the one or more climbing sections, or forming the one or more discrete climbing steps and the one or more integral climbing steps. Each integral climbing step of the one or more integral climbing steps extends from the front surface of the web of the channel with which the integral climbing step is integrally formed, includes a climbing surface, and is configured to receive at least one hand and/or at least one foot of a climber. When forming the one or more climbing steps includes forming the one or more discrete climbing steps, forming the one or more climbing sections also includes coupling at least one discrete climbing step of the one or more discrete climbing steps to the channel of at least one climbing section of the one or more climbing sections such that the at least one climbing section includes at least one connected climbing step. The at least one connected climbing step of the at least one climbing section extends from the front surface of the web of the channel to which the at least one connected climbing step is coupled, includes a climbing surface, and is configured to receive at least one hand and/or at least one foot of a climber.

In accordance with yet another aspect of the invention, a kit for a ladder system includes a plurality of climbing sections. Each climbing section includes a channel having a web with a front surface, a rear surface opposite the front surface, and a plurality of mounting holes extending from the front surface through the rear surface. The channel additionally includes a first flange, a second flange, and a channel opening formed between the first and second flanges. The first flange includes an outer surface defining a first side of the channel and extending from the front surface of the web, past the rear surface of the web, and to a first flange end point and includes an inner surface extending from the rear surface of the web to the first flange end point. The second flange includes an outer surface defining a second side of the channel and extending from the front surface of the web, past the rear surface of the web, and to a second flange end point and includes an inner surface extending from the rear surface of the web to the second flange end point. Each climbing section further includes one or more climbing steps, each climbing step extending from the front surface of the web, having a climbing surface, and configured to receive at least one hand and/or at least one foot of a climber. In addition, the kit includes a plurality of fasteners configured to mount each climbing section of the plurality of climbing sections via the plurality of mounting holes.

These and various other features and advantages of the present invention will be more readily understood from the following detailed description and the accompanying drawings.

### BRIEF DESCRIPTION OF THE DRAWINGS

The drawings illustrate embodiments presently contemplated for carrying out the invention.

In the drawings:

FIG. 1 is a perspective view of a ladder or climbing system including a plurality of ladder or climbing sections mounted on a tree, according to an embodiment of the invention.

FIG. 2 is a perspective view of a multi-step climbing section used in the ladder system of FIG. 1, according to an embodiment of the invention.

FIG. 3 is a front view of the multi-step climbing section of FIG. 2, according to an embodiment of the invention.

FIG. 4 is a rear view of the multi-step climbing section of FIG. 2, according to an embodiment of the invention.

FIG. 5 is a right-side view of the multi-step climbing section of FIG. 2, according to an embodiment of the invention.

FIG. 6 is a top view of the multi-step climbing section of FIG. 2, according to an embodiment of the invention.

FIG. 7 is a perspective view of a single-step climbing section used in the ladder system of FIG. 1, according to an embodiment of the invention.

FIG. 8 is a perspective view of another single-step climbing section used in the ladder system of FIG. 1, according to an embodiment of the invention.

FIG. 9 is a front view of the single-step climbing section of FIG. 8, according to an embodiment of the invention.

FIG. 10 is a right-side view of the single-step climbing section of FIG. 8, according to an embodiment of the invention.

FIGS. 11A-11D are partial perspective views of steps with anti-slip climbing surfaces that are usable in the climbing sections of FIGS. 1-10, according to embodiments of the invention.

### DETAILED DESCRIPTION

Embodiments of the present invention relate to a ladder or climbing system including one or more ladder or climbing sections and methods of making such a ladder system. Each climbing section includes a channel having a web with a front surface and a rear surface opposite the front surface. The channel also includes two flanges extending out from the rear surface of the web to create a channel opening. Each climbing section also includes one or more climbing steps or support bars. The climbing steps may be configured as rungs or crossbars that extend over or across a width of the front surface of the channel web or as extension support bars that extend out from the front surface of the channel web.

While embodiments of the invention are most often described herein with reference to use on a tree for providing access to a tree stand, those with skill in the art will understand that the concepts disclosed herein may be used in other circumstances or situations or for other purposes such as on or in barns, on utility poles, at construction sites, or on roofs, as non-limiting examples.

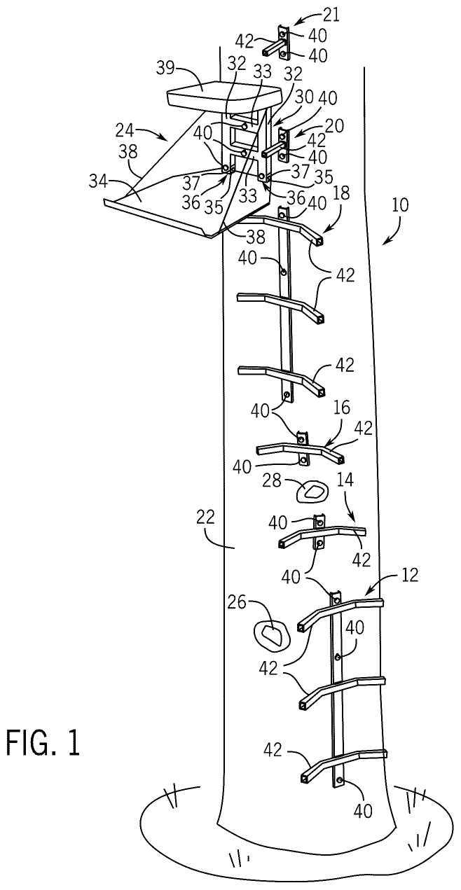

Referring to FIG. 1, a ladder or climbing system 10 including a plurality of ladder or climbing sections 12, 14, 16, 18, 20, 21 mounted on a tree 22 is shown, according to an embodiment of the invention. That is, the outer surface of tree 22 is the mounting surface for climbing sections 12, 14, 16, 18, 20, 21. Climbing sections 12, 14, 16, 18, 20, 21 are arranged on tree 22 to reach a hunting tree stand 24 while avoiding knots 26, 28 in tree 22. Tree stand 24 includes a mounting bracket 30 having two vertical support bars 32 and two horizontal support bars 33 formed integrally with and connecting vertical support bars 32. However, some embodiments may include a different configuration of vertical and/or horizontal support bars 32, 33. As a non-limiting example, tree stand 24 may include only one or more vertical support bars 32. As another non-limiting example, tree stand 24 may include one or three horizontal support bars 33. Furthermore, horizontal support bars 33 may be coupled to vertical support bars 32 via, for example, welding or fasteners, rather than being integrally formed with vertical support bars 32.

Tree stand 24 also includes a foldable base or platform 34 with a plurality of vertical plates 35 extending upward therefrom and forming a pair of openings 36. Each vertical support bar 32 of mounting bracket 30 is positioned within one opening 36 between two vertical plates 35. A pin 37 extends through each vertical support bar 32 of mounting bracket 30 and the corresponding vertical plates 35 of platform 34 such that platform 34 is rotatable with respect to mounting bracket 30. Tree stand 24 also includes a pair of wires 38 attaching platform 34 to mounting bracket 30 to limit how far platform 34 is able to rotate. Generally, wires 38 are configured such that platform 34 is substantially perpendicular to mounting bracket 30 when wires 38 are fully extended, but are not limited to such a configuration. In addition, tree stand 24 includes a seat 39 attached to mounting bracket 30 and extending substantially parallel to platform 34. Mounting bracket 30 is coupled to tree 22 via a plurality of fasteners 40 on vertical and horizontal support bars 32, 24, with some fasteners 40 on vertical support bars 32 hidden by seat 39.

Each of climbing sections 12, 14, 16, 18, 20, 21 is also mounted to tree 22 via a plurality of fasteners 40. Fasteners 40 may be galvanized to help prevent corrosion. During installation, fasteners 40 should be driven tight to tree 22 to make the load from a climber on climbing sections 12, 14, 16, 18, 20, 21 and mounting bracket 30 as vertical as possible. In other words, the load on climbing sections 12, 14, 16, 18, 20, 21 and mounting bracket 30 will be a shear load as opposed to a tensile axial load or leverage load that would make fasteners 40 more likely to be pulled out of the mounting surface during use. However, when mounted on other surfaces (such as, for example, a roof), climbing sections 12, 14, 16, 18, 20, 21 may be mounted at an angle.

Fasteners 40 should have a shear strength and a tensile strength capable of handling a climber thereon. These requirements may be different for different types of applications. Fasteners 40 should also have a holding power sufficient to prevent fasteners 40 from pulling out of the relevant mounting surface. Thus, in general, fasteners 40 will have ridges that aid in preventing fasteners 40 from pulling out of the mounting surface. As non-limiting examples, fasteners 40 may bolts or screws with threads or corrugated nails with one or more full rings around their shanks (also known as ring-shank nails or annular nails) and/or one or more partial rings around their shanks. As a more specific non-limiting example, fasteners 40 may be lag bolts or screws that can be installed using a drill or impact driver. For some applications, the lag bolts may be a minimum of ¼-inch (6.35 millimeters) in diameter and 3 inches (7.62 centimeters) in length. As another more specific non-limiting example, fasteners 40 may be sheeting nails that can be installed using a hammer or air compressor. Screw-shank or spiral-shank nails may also be considered since they turn as they are driven into a mounting surface, providing additional holding power. Smooth-shank nails are generally not preferred, but might be used in various applications when deemed safe.

The type of mounting surface may also impact which type of fastener is best for mounting climbing sections 12, 14, 16, 18, 20, 21. The mounting surface for climbing sections 12, 14, 16, 18, 20, 21 could be made of various materials such as, for example, wood (including trees, wooden beams, plywood, and oriented strand board (OSB), as non-limiting examples), metals, and/or concrete. Further, the mounting surface could be different variations or categories of those materials such as, for example, different types of wood (including trees), metals, or concrete. Some of these different materials may call for the use of fasteners of specific type, fasteners having a higher grade or class, and/or fasteners having an increased rating in at least one category such as minimum yield strength, minimum tensile strength, or proof load, as non-limiting examples. Moreover, some mounting surface materials may require longer and/or larger fasteners than others.

For safety reasons, each climbing section 12, 14, 16, 18, 20, 21 is typically designed to receive and should be mounted with at least two fasteners 40 where possible. This will aid in preventing any climbing sections 12, 14, 16, 18, 20, 21 from failing due to strain on a single fastener 40. Additionally, a single fastener 40 that only secures a climbing section 12, 14, 16, 18, 20, 21 at one point may not be able to prevent rotation of that climbing section 12, 14, 16, 18, 20, 21 during a climb.

Climbing sections 12, 14, 16, 18, 20, 21 are mounted on tree 22 via fasteners 40 such that a climber is able to reach tree stand 24. In some embodiments, fasteners 40 are specific to ladder system 10 in that they have a unique fastener head (not shown). In that case, the owner of ladder system 10 may have a unique driver for installing and uninstalling fasteners 40. This provides security to ladder system 10 in making it more difficult for another to steal any of climbing sections 12, 14, 16, 18, 20, 21.

As shown, climbing sections 12, 14, 16, 18, 20, 21 are not aligned with each other such that each climbing section 12, 14, 16, 18, 20, 21 is directly below and even with every other climbing section 12, 14, 16, 18, 20, 21, as knots 26, 28 in tree 22 prevent such alignment.

Instead, climbing sections 12, 14, 16, 18, 20, 21 are arranged to avoid knots 26, 28 while still providing a path for a climber to reach tree stand 24. Climbing sections 12, 14, 16, 18, 20, 21 are capable of providing such a path because climbing sections 12, 14, 16, 18, 20, 21 do not need to be joined together as a single ladder.

However, climbing sections 12, 14, 16, 18, 20, 21 can also be aligned with each other where such alignment is possible. As a non-limiting example, climbing sections 12, 14, 16, 18, 20, 21 may be aligned with each other on another tree (not shown) that does not have obstacles like knots 26, 28 in the desired direction for tree stand 24. Further, in some embodiments, climbing sections 12, 14, 16, 18, 20, 21 may be configured to overlap or connect with each other such that ladder system 10 is a continuous ladder system. As non-limiting examples, climbing sections 12, 14, 16, 18, 20, 21 may overlap or connect to each other via interlocking parts (not shown) or via a separate connector (not shown).

When attached to tree 22 via fasteners 40, climbing sections 12, 14, 16, 18, 20, 21 allow climbers to reach tree stand 24 via climbing steps or support bars 42. As shown, climbing sections 12, 18 are multi-step climbing sections including three steps 42 in the form of crossbars or rungs, climbing sections 14, 16 are single-step versions of climbing sections 12, 18, and climbing sections 20, 21 are single-step climbing sections that differ from climbing sections 14, 16 in that step 42 is an extension support bar. As noted above, climbing sections 12, 14, 16, 18, 20, 21 are arranged in a manner to reach tree stand 24, but the particular arrangement shown in FIG. 1 is not the only possible arrangement. As a non-limiting example, the positions of climbing sections 12, 14 and/or climbing sections 16, 18 may be switched. In addition, climbing section 12 may be positioned on the other side of knot 26 and climbing sections 14, 16 moved accordingly. The arrangement of climbing sections 12, 14, 16, 18, 20, 21 is based on the personal preference of the installer/climber.

Furthermore, climbing sections 12, 14, 16, 18, 20, 21 may individually have different configurations or may be replaced with a different type of climbing section. As a non-limiting example, multi-step climbing sections 12, 18 may include a different number of steps such as two or four steps. As another non-limiting example, multi-step climbing sections 12, 18 may be replaced with a plurality of single-step climbing sections configured in the same manner as single-step climbing sections 14, 16. As yet another non-limiting example, single-step climbing sections 20, 21 may be replaced with single-step climbing sections configured in the same manner as single-step climbing sections 14, 16. As still another non-limiting example, only single-steps climbing sections configured in the same manner as single-step climbing sections 14, 16 or in the same manner as single-step climbing sections 20, 21.

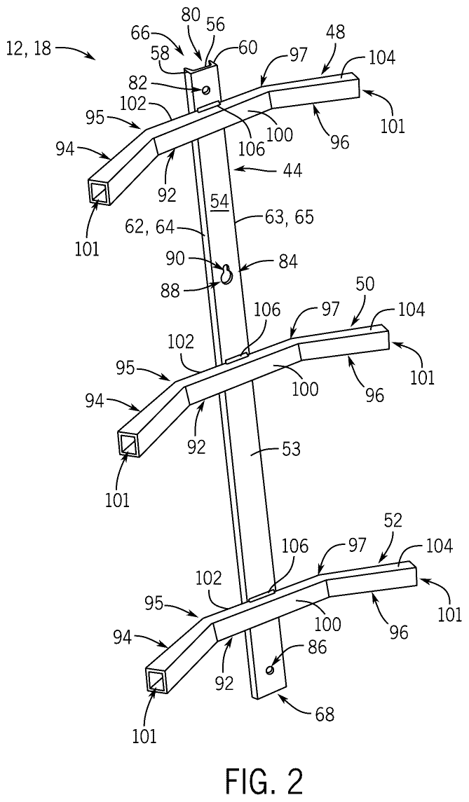

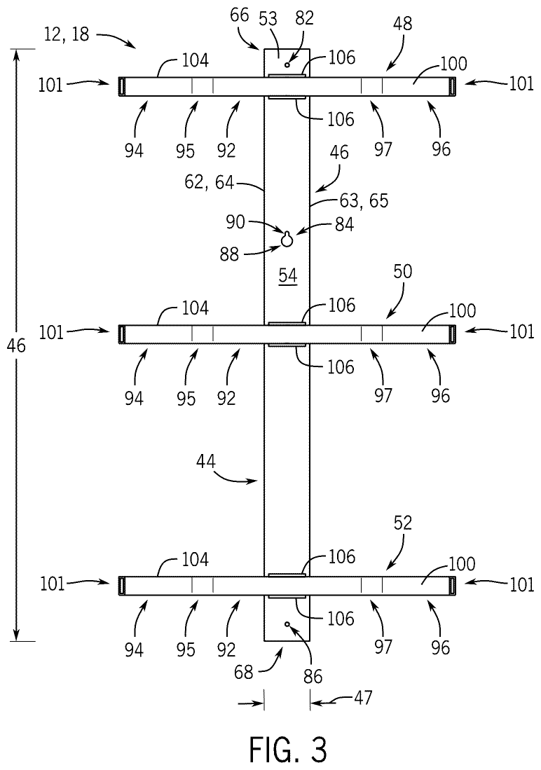

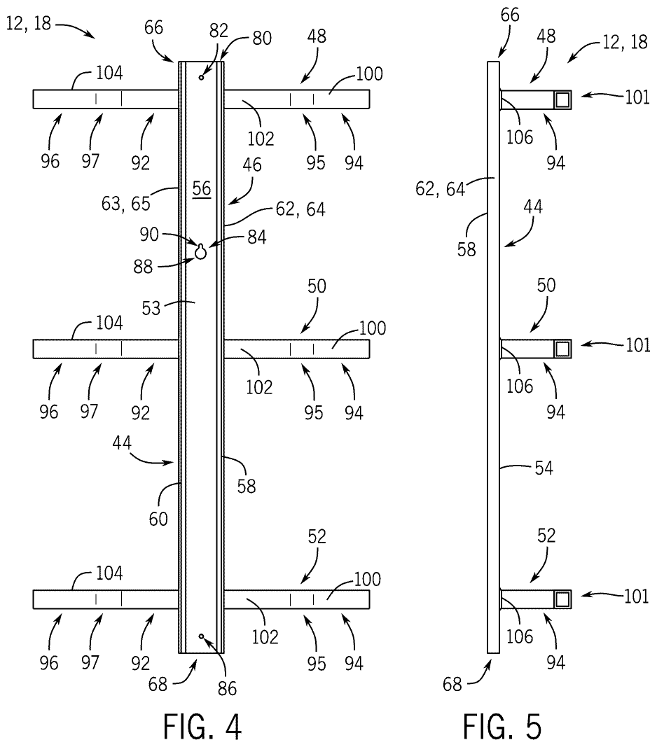

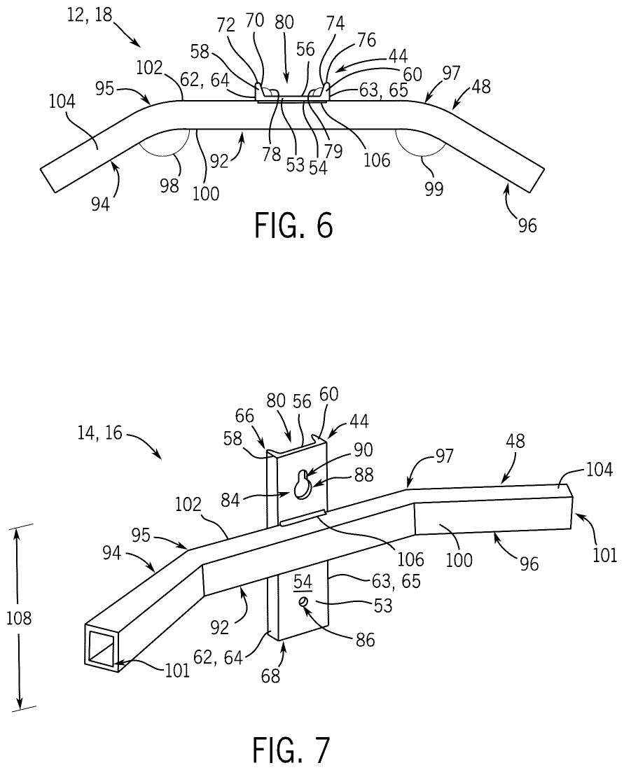

Referring now to FIGS. 2-6, multi-step climbing sections 12, 18 of ladder system 10 of FIG. 1 are shown, according to an embodiment of the invention. FIG. 2 is a perspective view of climbing sections 12, 18. FIG. 3 is a front view of climbing sections 12, 18. FIG. 4 is a rear view of climbing sections 12, 18. FIG. 5 is a right-side view of climbing sections 12, 18. FIG. 6 is a top view of climbing sections 12, 18. Since climbing sections 12, 18 of ladder system 10 have the same construction/configuration, only one climbing section 12, 18 is shown in FIGS. 2-6, and the description of FIGS. 2-6 will only reference climbing section 12, with all description of climbing section 12 being equally applicable to climbing section 18.

Climbing section 12 includes a channel 44 having a length 46 and a width 47. In FIGS. 2-6, steps 42 of climbing section 12 referenced in FIG. 1 are shown as crossbars or rungs 48, 50, 52 extending over or across width 47 of channel 44. Channel 44 includes a web 53 having a front surface 54 and a rear surface 56. Front surface 54 has the same length 46 and width 47 as channel 44. Thus, length 46 and width 47 may be attributed to both channel 44 and front surface 54.

Channel 44 also includes left and right flanges 58, 60 formed integrally with web 53 and having respective outer surfaces 62, 63 that extend from front surface 54 of web 53 and past rear surface 56 of web 53. Therefore, outer surfaces 62, 63 of flanges 58, 60 define respective left and right sides 64, 65 of channel 44. However, in various embodiments, web 53 may define left and right sides 64, 65 of channel 44, and outer surfaces 62, 63 may extend from rear surface 56 of web 53. Flanges 58, 60 generally extend along the entire length 46 of channel 44 from a top or upper end 66 of channel 44 to a bottom or lower end 68 of channel 44. However, in some embodiments, flanges 58, 60 may extend along only part of length 46 from upper or lower end 66, 68 of channel 44 or may be formed in segments along length 46 with a gap between each segment.

Left flange 58 includes an inner surface 70 that extends from rear surface 56 of web 53 to an end point 72 where it meets outer surface 62. Similarly, right flange 60 includes an inner surface 74 that extends from rear surface 56 of web 53 to an end point 76 where it meets outer surface 63. Inner surface 70 of left flange 58 extends from rear surface 56 of web 53 so as to form an angle 78 between left flange 58 and rear surface 56 that is between 90 and 180 degrees. Inner surface 74 of right flange 60 extends from rear surface 56 of web 53 so as to form an angle 79 between right flange 60 and rear surface 56 that is between 90 and 180 degrees. Typically, angles 78, 79 are the same or substantially the same, but angles 78, 79 may be different in some embodiments. Angles 78, 79 are formed within a channel opening or gap 80 between flanges 58, 60. Channel opening 80 extends the entire length 46 of channel 44.

Channel 44 also includes mounting holes or openings 82, 84, 86 that extend from front surface 54 of web 53 through rear surface 56 of web 53. Mounting holes 82, 86 have a circular shape. Mounting hole 84, on the other hand, has a keyhole shape. That is, mounting hole 84 includes a fastener head opening 88 and a keyhole slot 90 extending from fastener head opening 88. Fastener head opening 88 is sized to receive a fastener head (not shown in FIGS. 2-6) therethrough, and keyhole slot 90 is sized to prevent the fastener head from passing therethrough.

The keyhole shape of mounting hole 84 allows for an easy and convenient installation of climbing section 12 as follows. An installer may install a fastener partially into a mounting surface such as tree 22 of FIG. 1, as a non-limiting example. The installer can then place climbing section 12 onto the fastener by aligning the fastener with the fastener head opening 88 of mounting hole 84, moving climbing section 12 toward the mounting surface such that the fastener extends through fastener head opening 88, and then sliding climbing section 12 down onto the fastener such that the fastener is positioned in keyhole slot 90. Climbing section 12 can then hang on the fastener while the installer aligns climbing section 12 in the desired orientation and installs fasteners into mounting holes 82, 86. Finally, the installer may fully install the fastener in keyhole slot of mounting hole 84 such that the fastener is now tight against front surface 54 of web 53.

Referring again to FIG. 1, mounting bracket 30 of tree stand 24 may have some commonalities with channel 44 of climbing section 12. Initially, vertical support bars 32 of mounting bracket 30 may be configured as channels like channel 44 of climbing section 12 and include the same or similar features such as, for example, flanges like left and right flanges 58, 60, mounting holes with a circular shape like mounting holes 82, 86 and/or mounting holes with a keyhole shape like mounting holes 84. In fact, in some embodiments, mounting bracket 30 may be in the form of a channel 44 with the same or substantially the same configuration as in climbing section 12. However, these common features between vertical support bars 32 of mounting bracket 30 and channel 44 of climbing section 12 may not be arranged in the same way. As a non-limiting example, fasteners 40 may couple mounting bracket 30 to tree 22 in different locations than channel 44 of climbing section 12. As another non-limiting example, common features on vertical support bars 32 of mounting bracket 30 and channel 44 of climbing section 12 may have different dimensions, such as vertical support bars 32 being thicker than channel 44.

Referring again to FIGS. 2-6, crossbars 48, 50, 52 each include a channel section 92 extending over width 46 of front surface 54 of web 53, a left side section 94 extending or angled away from front surface 54 via a left bend 95, and a right side section 96 extending or angled away from front surface 54 via a right bend 97. Side sections 94, 96 are typically angled away from front surface 54 so that it is easier for a climber to utilize side sections 94, 96 as steps, especially when a mounting surface (not shown in FIGS. 2-6) is flat. That is, since side sections 94, 96 extend away from front surface 54 of web 53, they also extend away from the mounting surface and provide more area for a climber to step onto crossbars 48, 50, 52. However, in various embodiments, crossbars 48, 50, 52 may be formed as straight crossbars 48, 50, 52 without bends 95, 97 when such a configuration is deemed more useful or practical.

As shown in FIG. 6, bends 95, 97 form angles 98, 99 in crossbars 48, 50, 52. Angles 98, 99 are generally between 90 and 180 degrees, but more typically between 130 degrees and 160 degrees. Angle 98 is formed between left side section 94 and channel section 92 on a front surface 100 of each crossbar 48, 50, 52. Angle 99 is formed between right side section 96 and channel section 92 on front surface 100 of each crossbar 48, 50, 52.

Crossbars 48, 50, 52 are formed as metal tubing with a square cross-section and an opening 101 on each end. Crossbars 48, 50, 52 may have rounded corners between adjacent surfaces to prevent sharp edges from injuring a climber or may have square corners. Crossbars 48, 50, 52 may also have a different cross-section such a rectangular cross-section. In addition, while crossbars 48, 50, 52 are shown as tubes with a hollow interior to decrease their weight, crossbars 48, 50, 52 may alternatively be formed as solid pieces. Different types of metals may be used to form crossbars 48, 50, 52 such as, for example, aluminum or steel. These metals may be extruded to increase their strength.

Crossbars 48, 50, 52 each include a mounting or channel-facing surface 102 and a climbing surface 104. Mounting or channel-facing surface 102 is located on channel section 92 and coupled to front surface 54 of web 53 of channel 44 by welds 106. However, in some embodiments, channel section 92 may be coupled to channel 44 by other means such as, for example, fasteners. Further, in various embodiments, channel-facing surface 102 may be formed integrally with front surface 54. That is, crossbars 48, 50, 52 may be formed as a unit with channel 44. Where channel section 92 of crossbars 48, 50, 52 are formed integrally with front surface 54, crossbars 48, 50, 52 are considered integral climbing steps 48, 50, 52. Where channel section 92 of crossbars 48, 50, 52 are coupled to front surface 54, crossbars 48, 50, 52 are considered discrete climbing steps 48, 50, 52 prior to being coupled to front surface 54 and are considered connected climbing steps 48, 50, 52 after being coupled to front surface 54.

Referring now to FIG. 7, climbing sections 14, 16 of ladder system 10 of FIG. 1 are shown, according to an embodiment of the invention. Since climbing sections 14, 16 of FIG. 7 are single-step versions of climbing sections 12, 18 of FIGS. 2-6, climbing sections 14, 16 are arranged similarly to climbing sections 12, 18, and like elements are numbered identically to corresponding elements in climbing sections 12, 18. Further, as climbing sections 14, 16 of ladder system 10 have the same construction/configuration, only one climbing section 14, 16 is shown in FIG. 7, and the description of FIG. 7 will only reference climbing section 14, with all description of climbing section 14 being equally applicable to climbing section 16.

Climbing section 14 is different from climbing section 12 in that channel 44 of climbing section 14 has a length 108 that is shorter than length 46 of channel 44 of climbing section 12. Due to this shorter length 108, climbing section 12 has only one crossbar 48 and two mounting holes 84, 86. In climbing section 14, mounting hole 84 is in a different position near upper end 66 of channel 44. Mounting hole 86, on the other hand, is in substantially the same position. Otherwise, as explained above, climbing section 14 has the same construction/configuration as climbing section 12. Therefore, climbing section 14 has the same function as climbing section 12, but having a shorter length 108, climbing section 14 can fit in areas with less space. Moreover, the use of multiple climbing sections 14 in ladder system 10 may allow for a greater amount of customization in terms of the arrangement of ladder system 10 on a mounting surface (not shown in FIG. 7) due to the ability to mount climbing sections 14 as individual steps, as opposed to climbing sections 12, 18 that include multiple fixed steps.

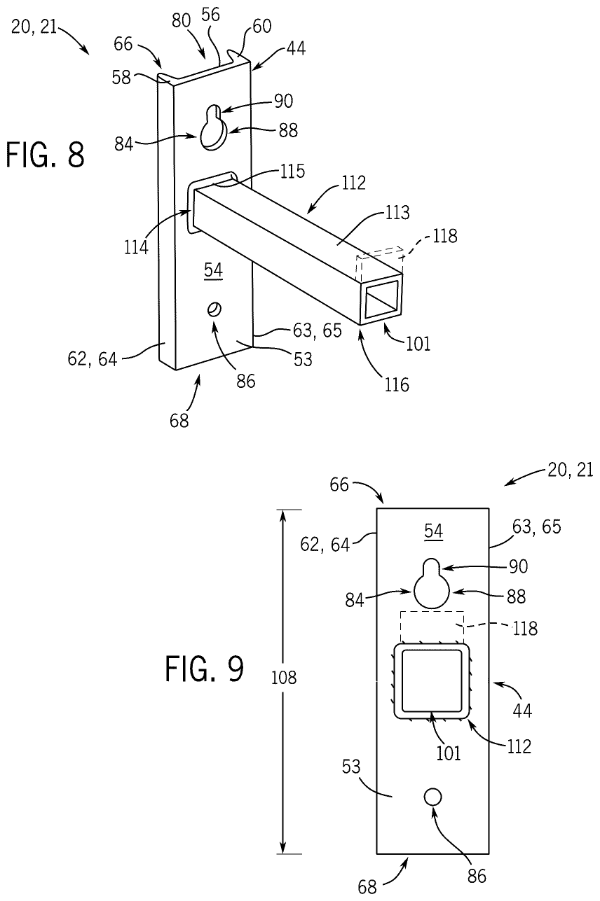

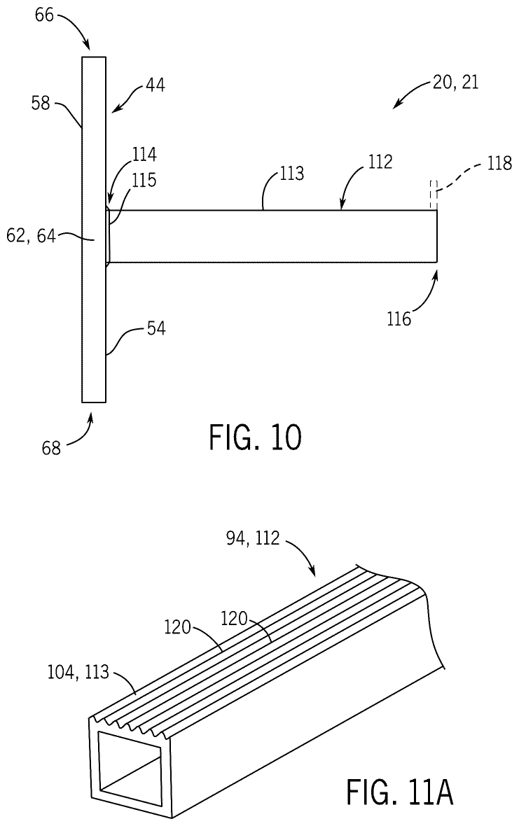

Referring now to FIGS. 8-10, climbing sections 20, 21 of ladder system 10 of FIG. 1 are shown, according to an embodiment of the invention. FIG. 8 is a perspective view of climbing sections 20, 21. FIG. 9 is a front view of climbing sections 20, 21. FIG. 10 is a right-side view of climbing sections 20, 21. Climbing sections 20, 21 differ from climbing sections 14, 16 of FIG. 7 in that climbing sections 20, 21 include an extension support bar 112 rather than crossbar 48. As such, like elements are numbered identically to corresponding elements in climbing sections 14, 16. Also, since climbing sections 20, 21 have the same construction/configuration, only one climbing section 20, 21 is shown in FIGS. 8-10, and the description of FIGS. 8-10 will reference only climbing section 20, with all description of climbing section 20 being equally applicable to climbing section 21.

As noted above, climbing section 20 differs from climbing section 14 by including extension support bar 112 that extends out from front surface 54 of web 53 of channel 44 between left and right sides 64, 65 of channel 44. Extension bar 112 extends from front surface 54 farther than crossbars 48, 50, 52. However, like crossbars 48, 50, 52, extension support bar 112 is formed as metal tubing with a square cross-section and an opening 101 on each end 114, 116. Extension support bar 112 may have rounded corners between adjacent surfaces to prevent sharp edges from injuring a climber or may have square corners. Extension support bar 112 may also have a different cross-section such a rectangular cross-section. In addition, while extension support bar 112 is shown as a tube with a hollow interior to decrease its weight, extension support bar 112 may alternatively be formed as a solid piece. Furthermore, extension bar 112 may be formed with an end plate (not shown) including a mounting hole to facilitate coupling extension bar 112 to channel 44. Different types of metals may be used to form extension support bar 112 such as, for example, aluminum or steel. These metals may be extruded to increase their strength.

Extension support bar 112 includes a climbing surface 113 extending between a first end 114 coupled to front surface 54 of web 53 of channel 44 via welds 115 and a second end 116 spaced apart from front surface 54. However, in some embodiments, extension support bar 112 may be coupled to channel 44 by other means such as, for example, fasteners. Further in various embodiments, extension support bar 112 may be formed integrally with channel 44 at front surface 54. That is, extension support bar 112 may be formed as a unit with channel 44. Where extension support bar 112 is formed integrally with channel 44, extension support bar 112 is considered an integral climbing step 112. Where extension support bar 112 is coupled to front surface 54 of channel 44, extension support bar 112 is considered a connected climbing step 112. Prior to being coupled to front surface 54, extension support bar 112 is considered a discrete climbing step 112.

Climbing section 20 may provide certain benefits over climbing section 14 in some situations. As a non-limiting example, a climber may find it more useful to have climbing section 20 with extension support bar 112 extending farther from front surface 54 of web 53 than crossbar 48 of climbing section 14. That is, extension support bar 112 of climbing section 20 provides climbing surface 113 at different angle with respect to front surface 54 than climbing surface 104 of crossbar 48 of climbing section 14, and this different angle may make it more comfortable for a climber. As another non-limiting example, a climber may more easily hang an object from extension bar 112 of climbing section 20 than crossbar 48 of climbing section 14. A climber may desire to hang an object from extension bar 112 in various circumstances, and placement of climbing section 20 near a work area or destination for ladder system 10 may be useful for a climber to hang equipment. To that end, extension bar 112 may optionally include a flange 118 at second end 116. Flange 118 may extend across the entirely of climbing surface 114, as shown, or only partially across climbing surface 114. Further, flange 118 may be positioned across climbing surface 114 at a location other than at second end 116.

While climbing section 20 is generally referenced as an alternative to climbing section 14, climbing section 20 is not limited to a single-step configuration. That is, in some embodiments, climbing section 20 could include multiple extension support bars 112. As a non-limiting example, climbing section 20 may include three extension support bars 112 on channel 44 in a configuration similar to crossbars 48, 50, 52 of climbing section 12 of FIGS. 2-6. As another non-limiting example, climbing section 20 could include a plurality of extension support bars 112 spaced apart on channel 44 by a different distance than crossbars 48, 50, 52 of climbing section 12. Multiple-step configurations of climbing section 20 may be useful under various circumstances such as, for example, in tight spaces where crossbars 48, 50, 52 are unable to fit and a climber would, therefore, find a multi-step climbing section 20 more useful.

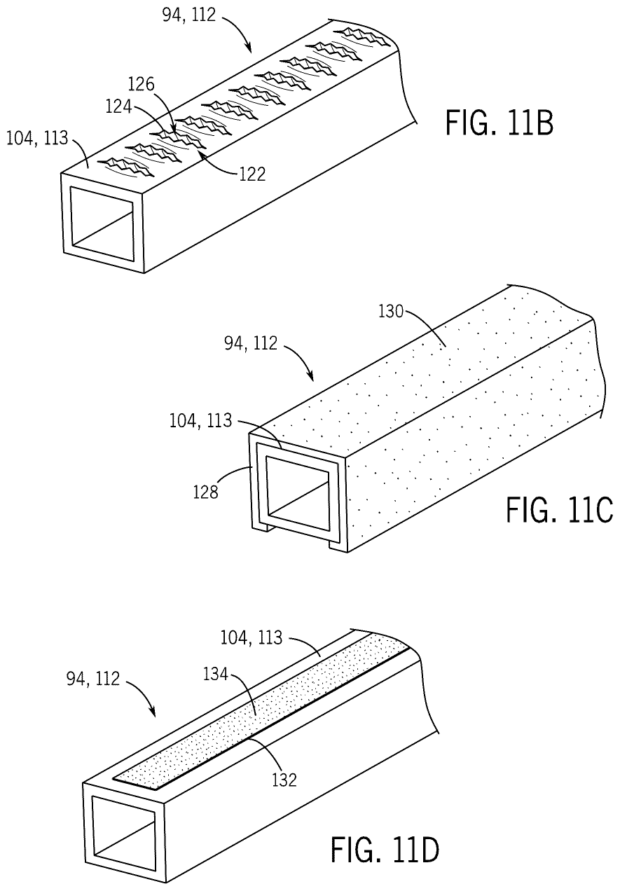

Referring now to FIGS. 11A-11D, partial perspective views of left side 94 of crossbars 48, 50, 52 and extension support bar 112 shown in FIGS. 1-10 are shown with climbing surfaces 104, 113 of crossbars 48, 50, 52 and extension support bar 112 as forming or including anti-slip, anti-skid, or non-slip surfaces, according to embodiments of the invention. While the descriptions of FIGS. 11A-11D reference only left side 94 of crossbars 48, 50, 52 and extension support bar 112, the anti-slip, anti-skid, or non-slip surfaces shown in FIGS. 11A-11D are equally applicable to right side 96 of crossbars 48, 50, 52. Initially referring to FIG. 11A, FIG. 11A is a partial perspective view of left side 94 of crossbars 48, 50, 52 and extension support bar 112 with ridges 120. Ridges 120 are shown as being sharp edges and, therefore, may be considered serrations. However, in various embodiments, ridges 120 may be flat that are spaced apart from each other to form ribbed treads across climbing surfaces 104, 113.

Referring now to FIG. 11B, FIG. 11B is a partial perspective view of left side 94 of crossbars 48, 50, 52 and extension support bar 112 with treads 122 having jagged edges 124 forming openings 126 though climbing surfaces 104, 113. Since treads 122 are shown with jagged edges 124, treads 122 are considered serrated treads 122. Generally, serrated treads 122 are aggressive and provide a high amount of grip for a climber. However, due to their aggressiveness, climbers may desire a less aggressive alternative. Thus, in some embodiments, treads 122 may be perforated treads (also called perforated buttons) with edges 124 that are smooth and non-aggressive around openings 126. While perforated treads do not offer as much grip as serrated treads, perforated treads will typically feel more comfortable to a climber than serrated treads while still providing more grip than a smooth surface.

Referring now to FIG. 11C, FIG. 11C is a partial perspective view of left side 94 of crossbars 48, 50, 52 and extension support bar 112 with a ladder step cover 128. Ladder step cover 128 wraps around left side 94 of crossbars 48, 50, 52 and extension support bar 112 and may be held in place by tension or adhesive, as non-limiting examples. Ladder step cover 128 may wrap entirely or only partially around left side 94 of crossbars 48, 50, 52 and extension support bar 112. Ladder rung cover 128 provides additional grip for a climber via a textured surface 130. That is, textured surface 130 will include small to large abrasive particles or ridges that aid in preventing a climber from slipping.

Referring now to FIG. 11D, FIG. 11D is a partial perspective view of left side 94 of crossbars 48, 50, 52 and extension support bar 112 with anti-slip, anti-skid, or non-slip tape 132 having a textured surface 134. Tape 132 is applied via an adhesive. Textured surface 134 has a similar configuration to textured surface 130 of ladder rung cover 128 of FIG. 11C. More specifically, textured surface 134 will include small to large abrasive particles or ridges that aid in preventing a climber from slipping.

Climbing sections 12, 14, 16, 18, 20, 21 of ladder system 10 may generally be manufactured by forming channel 44 and forming climbing steps 42 as crossbars 48, 50, 52 of climbing sections 12, 14, 16, 18 or extension support bars 112 of climbing sections 20, 21. Forming climbing steps 42 may involve forming integral climbing steps 42 integrally with channel 44 or separately from channel 44. Where climbing steps 42 are formed separately from channel 44, climbing steps 42 are considered discrete climbing steps 42. Once discrete climbing steps 42 are coupled to channel 44 (by, as a non-limiting example, welding), discrete climbing steps 42 are considered connected climbing steps 42. Channel 44 and climbing steps 42 may be formed by various processes such as, for example, die casting or metal extrusion.

The die casting process utilizes molds or dies to form precise metal parts. Molten metal is forced into cavities within the molds under high pressure and at a high speed. Once the metal cools and hardens within the mold, the metal is the desired shape. The die casting process may be used to create climbing sections 12, 14, 16, 18, 20, 21 of ladder system 10 by utilizing molds for channel 44, molds for crossbars 48, 50, 52 of climbing sections 12, 14, 16, 18, molds for extension support bar 112 of climbing sections 20, 21, and/or molds for climbing sections 12, 14, 16, 18, 20, 21 in their entireties.

Metal extrusion is a process that uses a high pressure to force metal material through an opening of a die or die stack. The die opening has a specific shape to create an extruded profile. Different metals may be used in an extrusion process such as, for example, aluminum and steel. However, the extrusion process will described below with respect to aluminum as a non-limiting example.

The aluminum extrusion process starts with casting aluminum alloy logs. Casting the logs involves melting high purity aluminum in a furnace along with alloying elements, such as, for example, magnesium (Mg), silicon (Si), copper (Cu), or manganese (Mn), as non-limiting examples. The alloying elements are added to achieve a desired strength or other material characteristics imparted by the alloy. Once melted, molten aluminum alloy pours out of the furnace and into a filtration box to remove unwanted gases and filter impurities out of the liquid metal. After leaving the filtration box, the molten metal travels through a trough and into a casting unit. Many logs may be cast at one time. During the casting process, the grain of the metal is also refined to desired characteristics.

After the casting process is complete, the cast aluminum logs go through a homogenization process to improve their microstructure. Homogenization is a high-temperature, thermal process used to optimize extrudability and extrusion characteristics. One purpose of homogenization is to achieve a better distribution of the alloy elements throughout the aluminum. In general, homogenization aids in preventing defects, streaked texture after anodizing, and poor mechanical properties, as non-limiting examples.

After the cast logs are cooled from homogenization, the logs are then cut into shorter lengths called billets. The length of the billets will depend on the length of the finished part. As a non-limiting example, billet length can vary from 20 inches to 50 inches (from approximately 60 centimeters to 127 centimeters). Prior to extrusion, the billets are reheated to a temperature that makes the material malleable, but not molten, and that achieves a desired strength, depending on alloy temper requirements. As a non-limiting example, the temperature may be in a range from approximately 800 to approximately 1000 degrees Fahrenheit (from approximately 425 to approximately 540 degrees Celsius). However, the proper temperature will depend on the exact composition of the billets.

Further, the temperature may vary according to industry tolerances. For best results, the billet should be heated uniformly throughout. The billet heating may be performed using a gas-fired furnace or induction heating, as non-limiting examples. The die also needs to be heated to a suitable temperature, as extruding hot billets through cold dies is dangerous and can break the die.

Each heated billet is placed into a steel cylinder or container and then forced through the container by a ram under as much as approximately 100,000 pounds per square inch (psi or lbs./in²) or approximately 690 megapascals (MPa) of pressure. A die stack at the far end of the container holds the opening through which aluminum is extruded to form the desired shape. A ram pushes the billets into the container and continues to push while the aluminum begins to exit through the die opening. When the extrusion emerges from the front of the press, the material temperature may still be approximately 1000 degrees Fahrenheit (approximately 540 degrees Celsius). The extrusion process can require specialized dyes and extensive tooling for each press and specific shape.

Once the material is extruded it will be cooled by quenching. Quenching the extruded material locks the elements and phases of alloy microstructure to achieve the desired strength requirements. After being quenched, a stretcher is used on the extruded material for straightness and stress relief and sawed to working links. Finally, the extrusion is aged to desired temper, tested for physical and chemical properties, and further fabricated and finished, as necessary. Additional fabrication and finishing steps might include punching, drilling, CNC machining, fusion or friction-stir welding, painting, anodizing, or powder coating.

In view of the above, it may be desirable to use metal extrusion to form channel 44 and climbing steps 42 of climbing sections 12, 14, 16, 18, 20, 21 of ladder system 10. Metal extrusion may aid in controlling the desired properties of channel 44 and climbing steps 42. Further, metal extrusion lends itself to a high volume of manufacturing. Thus, metal extrusion may aid in manufacturing ladder system 10.

Beneficially, embodiments of the invention thus provide a ladder or climbing system including one or more ladder or climbing sections. Each climbing section includes a channel having a web with a front surface, a rear surface opposite the front surface, and a plurality of mounting holes extending from the front surface through the rear surface for mounting the climbing section to a surface via fasteners. At least one of the plurality of mounting holes may include a keyhole slot to aid an installer trying align the climbing section vertically (in other words, make the climbing section substantially plumb). The channel additionally includes two flanges extending from the rear surface of the web and forming a channel opening. Each climbing section also includes one or more climbing steps or support bars. The climbing steps may be in the form of crossbars or rungs that extend across or over the front surface of the channel web or extension support bars that extend out from the front surface of the channel web. Climbing steps in the form of crossbars may include bends that aid a user when climbing.

The ladder system provides a secure structure for climbing in various different circumstances. Since the ladder system is mounted via fasteners, climbers will not experience the bouncing present in other ladder systems. The use of fasteners also make the ladder system easy to install and uninstall. In addition, the use of multiple shorter climbing sections instead of a single large climbing section makes installation of the ladder system easier because the shorter sections are less bulky and less complex. The use of multiple climbing sections also makes installation and uninstallation more customizable. During installation, a user is not required to install the climbing sections in a straight line in order to avoid obstacles. During uninstallation, a user may elect to leave the uppermost climbing sections in place and only remove the lowest climbing section or sections for security and convenience purposes. When the user leaves with the lowest climbing section or sections, another climber cannot access the uppermost climbing sections, and when the user returns, the user will not need to reinstall every climbing section. Further, the channel flanges aid in aligning the ladder vertically and rotationally. As a non-limiting example, the channel flanges may be arranged in the gaps in tree bark to help secure a climbing section to the tree. As another non-limiting example, when a climbing section is mounted, its channel flanges will dig into the mounting surface to aid in preventing unwanted movement during a climb.

One skilled in the art will appreciate that methods of manufacturing embodiments of the invention may be interfaced to and controlled by a computer readable storage medium having stored thereon a computer program. The computer readable storage medium may include a plurality of components such as, for example, one or more of electronic components, hardware components, and/or computer software components. These components may include one or more computer readable storage media that generally store instructions such as software, firmware, and/or assembly language for performing one or more portions of one or more implementations or embodiments of a sequence. These computer readable storage media are generally non-transitory and/or tangible. Examples of such a computer readable storage medium include a recordable data storage medium of a computer and/or storage device. The computer readable storage media may employ, for example, one or more of a magnetic, electrical, optical, biological, and/or atomic data storage medium. Further, such media may take the form of, for example, floppy disks, magnetic tapes, CD-ROMs, DVD-ROMs, hard disk drives, and/or electronic memory. Other forms of non-transitory and/or tangible computer readable storage media not listed may be employed with embodiments of the invention.

A number of such components can be combined or divided in an implementation of a system. Further, such components may include a set and/or series of computer instructions written in or implemented with any of a number of programming languages, as will be appreciated by those skilled in the art. In addition, other forms of computer readable media, such as a carrier wave, may be employed to embody a computer data signal representing a sequence of instructions that, when executed by one or more computers, causes the one or more computers to perform one or more portions of one or more implementations or embodiments of a sequence.

Therefore, according to one embodiment of the invention, a ladder system includes one or more climbing sections. Each climbing section includes a channel having a web with a front surface, a rear surface opposite the front surface, and a plurality mounting holes. Each mounting hole extends from the front surface through the rear surface and is configured to receive a fastener for mounting the climbing section. The channel also includes first and second flanges extending away from the rear surface of the web to form a channel opening therebetween. Each climbing section further includes one or more climbing steps. Each climbing step extends from the front surface of the web, includes a climbing surface, and is configured to receive at least one hand and/or at least one foot of a climber.

According to another embodiment of the invention, a method of manufacturing a ladder system includes forming one or more climbing sections. Forming the one or more climbing sections includes forming a channel for each climbing section of the one or more climbing sections. The channel of each climbing section of the one or more climbing sections includes a web having a front surface, a rear surface opposite the front surface, and a plurality mounting holes, each mounting hole extending from the front surface through the rear surface and configured to receive a fastener for mounting the climbing section. The channel for each climbing section additionally includes first and second flanges extending away from the rear surface of the web to form a channel opening therebetween. Furthermore, forming the one or more climbing sections includes forming one or more climbing steps for each climbing section of the one or more climbing sections by forming one or more discrete climbing steps separately from each channel of the one or more climbing sections, forming one or more integral climbing steps integrally with the channel of at least one climbing section of the one or more climbing sections, or forming the one or more discrete climbing steps and the one or more integral climbing steps. Each integral climbing step of the one or more integral climbing steps extends from the front surface of the web of the channel with which the integral climbing step is integrally formed, includes a climbing surface, and is configured to receive at least one hand and/or at least one foot of a climber. When forming the one or more climbing steps includes forming the one or more discrete climbing steps, forming the one or more climbing sections also includes coupling at least one discrete climbing step of the one or more discrete climbing steps to the channel of at least one climbing section of the one or more climbing sections such that the at least one climbing section includes at least one connected climbing step. The at least one connected climbing step of the at least one climbing section extends from the front surface of the web of the channel to which the at least one connected climbing step is coupled, includes a climbing surface, and is configured to receive at least one hand and/or at least one foot of a climber.

According to yet another embodiment of the invention, a kit for a ladder system includes a plurality of climbing sections. Each climbing section includes a channel having a web with a front surface, a rear surface opposite the front surface, and a plurality of mounting holes extending from the front surface through the rear surface. The channel additionally includes a first flange, a second flange, and a channel opening formed between the first and second flanges. The first flange includes an outer surface defining a first side of the channel and extending from the front surface of the web, past the rear surface of the web, and to a first flange end point and includes an inner surface extending from the rear surface of the web to the first flange end point. The second flange includes an outer surface defining a second side of the channel and extending from the front surface of the web, past the rear surface of the web, and to a second flange end point and includes an inner surface extending from the rear surface of the web to the second flange end point. Each climbing section further includes one or more climbing steps, each climbing step extending from the front surface of the web, having a climbing surface, and configured to receive at least one hand and/or at least one foot of a climber. In addition, the kit includes a plurality of fasteners configured to mount each climbing section of the plurality of climbing sections via the plurality of mounting holes.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims. In the appended claims, the singular forms of “a,” “an,” and “the” include their corresponding plural references unless the context clearly dictates otherwise.

What is claimed is:

1. A ladder system comprising:
one or more climbing sections, each climbing section comprising:
a channel comprising:
a web comprising:
a front surface;
a rear surface opposite the front surface; and
a plurality mounting holes, each mounting hole extending from the front surface through the rear surface and configured to receive a fastener for mounting the climbing section; and
first and second flanges extending away from the rear surface of the web to form a channel opening therebetween; and
one or more climbing steps, each climbing step:
extending from the front surface of the web;
comprising a climbing surface; and
configured to receive at least one hand and/or at least one foot of a climber.

2. The ladder system of claim 1 wherein each climbing step of each climbing section is a connected climbing step welded to the front surface of the web from which it extends.

3. The ladder system of claim 1 wherein each climbing step of each climbing section is an integral climbing step formed integrally with the front surface of the web from which it extends.

4. The ladder system of claim 1 wherein:
the one or more climbing sections comprise a first climbing section;
the one or more climbing steps of the first climbing section consist of a single climbing step; and
the single climbing step comprises an extension support bar extending from the front surface of the web of the channel of the first climbing section between opposing first and second sides of the channel.

5. The ladder system of claim 1 wherein:
the one or more climbing sections comprise a first climbing section; and
the one or more climbing steps of the first climbing section comprise at least two climbing steps.

6. The ladder system of claim 5 wherein each climbing step of the at least two climbing steps of the first climbing section comprises a crossbar, each crossbar comprising:
a channel-facing surface extending over a width of the front surface of the web; and
a front surface opposite the channel-facing surface.

7. The ladder system of claim 6 wherein each crossbar of the first climbing section comprises:
a channel section extending over the width of the front surface of the web, the channel section comprising:
a first end; and
a second end opposite the first end;
a first side section extending away from the front surface of the web;
a first bend extending between the first end of the channel section and the first side section and defining a first angle between the first side section and the channel section on the front surface of the crossbar as between 90 degrees and 180 degrees;
a second side section extending away from the front surface of the web; and
a second bend extending between the second end of the channel section and the second side section and defining a second angle between the second side section and the channel section on the front surface of the crossbar as between 90 degrees and 180 degrees.

8. The ladder system of claim 1 wherein at least one mounting hole of the one or more mounting holes of the web of the channel of each climbing section comprises a keyhole slot.

9. The ladder system of claim 1 wherein the climbing surface of each climbing step of each climbing section comprises an anti-slip surface.

10. The ladder system of claim 1 wherein:
the first flange of each channel of each climbing section comprises:
an outer surface defining a first side of the channel and extending from the front surface of the web, past the rear surface of the web, and to a first flange end point; and
an inner surface extending from the rear surface of the web to the first flange end point at a first angle between the first flange and the rear surface of the web within the channel opening as between 90 and 180 degrees; and
the second flange of each channel of each climbing section comprises:
an outer surface defining a second side of the channel and extending from the front surface of the web, past the rear surface of the web, and to a second flange end point; and
an inner surface extending from the rear surface of the web to the second flange end point at a second angle between the second flange and the rear surface of the web within the channel opening as between 90 and 180 degrees.

11. The ladder system of claim 1 wherein the at least one climbing section comprises a plurality of climbing sections.

12. A method of manufacturing a ladder system, the method comprising:
forming one or more climbing sections by:
forming a channel for each climbing section of the one or more climbing sections, the channel of each climbing section of the one or more climbing sections comprising:
a web comprising:
a front surface;
a rear surface opposite the front surface; and
a plurality mounting holes, each mounting hole extending from the front surface through the rear surface and configured to receive a fastener for mounting the climbing section; and
first and second flanges extending away from the rear surface of the web to form a channel opening therebetween;
forming one or more climbing steps for each climbing section of the one or more climbing sections by:
forming one or more discrete climbing steps separately from each channel of the one or more climbing sections;
forming one or more integral climbing steps integrally with the channel of at least one climbing section of the one or more climbing sections, each integral climbing step of the one or more integral climbing steps:
extending from the front surface of the web of the channel with which the integral climbing step is integrally formed;
comprising a climbing surface; and
configured to receive at least one hand and/or at least one foot of a climber; or
forming the one or more discrete climbing steps and the one or more integral climbing steps; and
when forming the one or more climbing steps comprises forming the one or more discrete climbing steps, coupling at least one discrete climbing step of the one or more discrete climbing steps to the channel of at least one climbing section of the one or more climbing sections such that the at least one climbing section comprises at least one connected climbing step, the at least one connected climbing step of the at least one climbing section:
extending from the front surface of the web of the channel to which the at least one connected climbing step is coupled;
comprising a climbing surface; and
configured to receive at least one hand and/or at least one foot of a climber.

13. The method of claim 12 wherein:
forming the channel for each climbing section of the one or more climbing sections comprises using an extrusion process; and
forming the one or more climbing steps for each climbing section of the one or more climbing sections comprises using an extrusion process.

14. The method of claim 12 wherein:
the extrusion process for forming the channel for each climbing section of the one or more climbing sections comprises an aluminum extrusion process; and
the extrusion process for forming the one or more climbing steps for each climbing section of the one or more climbing sections comprises an aluminum extrusion process.

15. The method of claim 12 wherein forming the one or more climbing steps for each climbing section of the one or more climbing sections comprises forming a plurality of the one or more discrete climbing steps as crossbars by:
forming a length of metal tubing having a square or rectangular cross section;
cutting the length of metal tubing into crossbars; and
bending each crossbar such that, when coupled to the channel of one climbing section of the one or more climbing sections, each crossbar comprises:
a channel section extending over the width of the front surface of the web of the channel to which the crossbar is coupled, the channel section comprising:
a first end; and
a second end opposite the first end; and
first and second side sections extending from the first and second ends of the channel section, respectively, and away from the front surface of the web.

16. The method of claim 12 wherein:
forming the one or more climbing steps for each climbing section of the one or more climbing sections comprises forming the one or more discrete climbing steps; and
coupling the at least one discrete climbing step of the one or more discrete climbing steps to the channel of the at least one climbing section of the one or more climbing sections comprises welding the at least one discrete climbing step to the front surface of the web of the channel of at least one climbing section.

17. A kit for a ladder system, the kit comprising:
a plurality of climbing sections, each climbing section comprising:
a channel comprising:
a web comprising:
a front surface;
a rear surface opposite the front surface; and
a plurality of mounting holes extending from the front surface through the rear surface;
a first flange comprising:
an outer surface defining a first side of the channel and extending from the front surface of the web, past the rear surface of the web, and to a first flange end point; and
an inner surface extending from the rear surface of the web to the first flange end point;
a second flange comprising:
an outer surface defining a second side of the channel and extending from the front surface of the web, past the rear surface of the web, and to a second flange end point; and
an inner surface extending from the rear surface of the web to the second flange end point; and
a channel opening formed between the first and second flanges; and
one or more climbing steps, each climbing step:
extending from the front surface of the web;
comprising a climbing surface; and
configured to receive at least one hand and/or at least one foot of a climber; and
a plurality of fasteners configured to mount each climbing section of the plurality of climbing sections via the plurality of mounting holes.

18. The kit of claim 17 wherein:
the plurality of climbing sections comprises a first climbing section;
the one or more climbing steps of the first climbing section comprise a plurality of climbing steps; and
each climbing step of the plurality of climbing steps of the first climbing section comprises a crossbar, each crossbar comprising a channel-facing surface extending over a width of the front surface of the web.

19. The kit of claim 18 wherein each crossbar of the channel of the first climbing section comprises:
a channel section extending over the width of the front surface of the web, the channel section comprising:
a first end; and
a second end opposite the first end; and
first and second side sections extending from the first and second ends of the channel section, respectively, and away from the front surface of the web.

20. The kit of claim 18 wherein:
the plurality of climbing sections comprises a second climbing section;
the one or more climbing steps of the second climbing section consist of a single climbing step; and
the single climbing step comprises an extension support bar extending out from the front surface of the web of the channel of the second climbing section between the first and second sides of the channel.
